(19) United States
(12) Patent Application Publication
(10) Pub. No.: US 2014/0118463 A1
(43) Pub. Date: May 1, 2014

(54) VIDEO PHONE SYSTEM

(71) Applicants: Fei Lu, Beijing (CN); Dongsheng Qu, Beijing (CN); Bing Lin, Beijing (CN)

(72) Inventors: Fei Lu, Beijing (CN); Dongsheng Qu, Beijing (CN); Bing Lin, Beijing (CN)

(73) Assignee: THOMSON LICENSING, Issy de Moulineaux (FR)

(21) Appl. No.: 14/124,862

(22) PCT Filed: Jun. 8, 2012
(86) PCT No.: PCT/CN2012/076632

§ 371 Date: Dec. 9, 2013

(30) Foreign Application Priority Data
Jun. 10, 2011 (CN) PCT/CN2011/075599

(51) Int. Cl. H04N 7/14

(52) U.S. Cl. CPC H04N 7/148
USPC 348/14.02

(57) ABSTRACT

An apparatus is provided. It comprises: a VoIP gateway for communicating voice data of a video call stream over a DECT channel between at least one DECT terminal and a peer; and a WiFi access point for communicating video data of a video call stream over a WiFi channel between at least one WiFi video terminal and the peer.

### TECHNICAL FIELD

The present invention generally relates to wireless communication. In particular, the present invention relates to a DECT (Digital Enhanced Cordless Telecommunications) based video phone system.

### BACKGROUND

This section is to provide the reader with background information to facilitate a better understanding of the various aspects of the present invention. It should not be understood as admissions of prior art.

DECT is a digital communication standard, which is primarily used for creating cordless phone systems. A DECT phone system is popular. A DECT phone base of the DECT phone system can be integrated with a VoIP gateway to provide a SIP (Session Initiation Protocol, a signaling protocol widely used for controlling communication sessions such as voice and video calls over Internet Protocol) call on the outside line of the system and a DECT call on the inside line. However, since DECT does not support video transport, an outside SIP video call cannot enter inside a DECT phone system.

On the other hand, a phone set inside the DECT phone system, which supports WiFi, can take video call directly on SIP rather than DECT. Therefore, the media transportation of video SIP call will be on WiFi. However, a home WiFi network normally has a worse capacity of real-time media transportation compared with DECT, which will result in a poor voice performance during SIP video call on WiFi.

### SUMMARY

According one aspect of the invention, an apparatus is provided. The apparatus comprises: a VoIP gateway for communicating voice data of a video call stream over a DECT channel between at least one DECT terminal and a peer; and a WiFi access point for communicating video data of a video call stream over a WiFi channel between at least one WiFi video terminal and the peer.

It is to be understood that more aspects and advantages of the invention will be found in the following detailed description of the present invention.

### BRIEF DESCRIPTION OF THE DRAWINGS

The accompanying drawings, which are included to provide a further understanding of the illustrate embodiments of the invention together with the description which serves to explain the principle of the invention. Therefore, the invention is not limited to the embodiments. In the drawings:

FIG. 1 is an exemplary diagram showing a structure of a video phone system according to an embodiment of the present invention;

FIG. 2 is an exemplary diagram showing the state machine of video on the DECT base according to an embodiment of the present invention;

FIG. 3 is an exemplary diagram showing a state transfer of an incoming call according to an embodiment of the present invention; and

FIGS. 4-14 are exemplary diagrams showing sequence charts of respective operations of the video phone system according to an embodiment of the invention.

### DETAILED DESCRIPTION

An embodiment of the present invention will now be described in detail in conjunction with the drawings. In the following description, some detailed descriptions of known functions and configurations may be omitted for clarity and conciseness.

According to an embodiment of the present invention, a video phone system is provided wherein, for an incoming video call, the voice data and video data of the video call are transmitted in separated channels within the video phone system. In particular, the voice data is transmitted on DECT channel and the video data will be transmitted on WiFi channel.

In the embodiment, DECT channel is used for voice data transmission since DECT has a voice performance much better than WiFi. Given the fact that people is normally more sensitive to voice than to video during a phone call, it is meaningful to have the voice data transmitted on DECT channel. At the same time, WiFi channel is used for video data transmission since WiFi has a video performance better than DECT.

Next, a video phone system according to the embodiment of the invention will be described in detail. In the video phone system, a DECT base will be a control center for receiving SIP video call from an external SIP network and implement a video phone function by transmitting the voice data and video data respectively on DECT and WiFi channels. The voice data can be reproduced on a DECT handset registered to the DECT base. The video data can be reproduced on a multimedia mobile terminal which supports WiFi and DECT and is registered to the DECT base. For example, the mobile terminal could be a wireless Tablet.

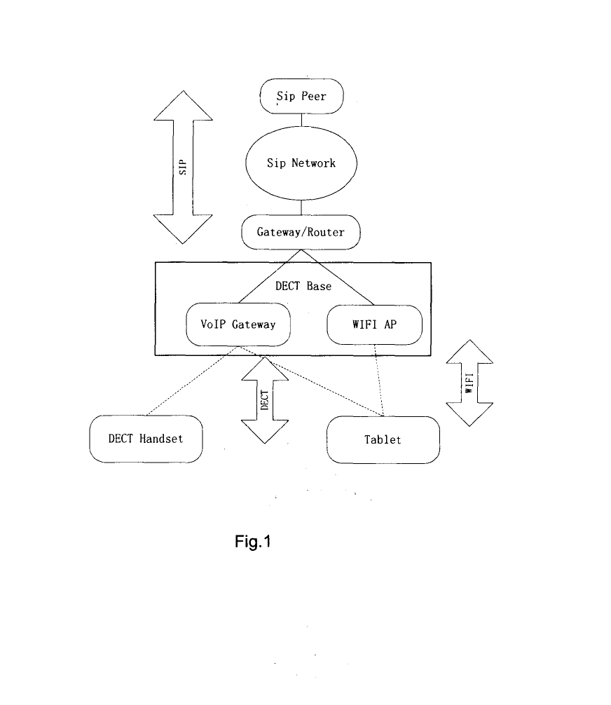

FIG. 1 is an exemplary diagram showing a network structure of a video phone system according to an embodiment of the invention.

As shown in FIG. 1, the video phone system comprises a DECT phone and one or more Tablets (only one Tablet is shown in FIG. 1). The DECT phone comprises a DECT base and one or more DECT handsets registered to the DECT base (only one handset is shown in FIG. 1). It is not necessary for the Tablet to have a SIP stack. The embodiment in FIG. 1 shows the case that the Tablet does not have a SIP stack. The DECT base is provided with a VoIP gateway and a WiFi Access Point (AP), which therefore is responsible for SIP communication with SIP network and protocol conversion between SIP and DECT. The communication between the DECT base and the Tablet, which controls several actions of video on the Tablet and makes responses for notification from the Tablet, will be described later.

In the network shown in FIG. 1, there is a router which is responsible for building local IP sub-network. The WAN port of the router is connected to SIP network with ADSL, through which a communication with a SIP peer can be established. The DECT base with VoIP gateway is connected to the router through outside line port. And the WiFi AP of the DECT base can be connected to the router through WAN port. The DECT handset and the Tablet are registered to the DECT base.

In the network shown in FIG. 1, when a SIP call is established between a remote SIP peer and the DECT base, the DECT base will play the role of a bridge for establishing a DECT-based video call between the DECT base and the DECT handset and the Tablet. The DECT base functions as a SIP client and a remote video controller and the Tablet can be seen as a DECT phone with video extension.

In the video phone system as shown in FIG. 1, since the Tablet does not have a SIP stack, the one or more DECT handsets and the Tablet can share one SIP account, in which case the DECT base will play the role of IP-to-DECT PABX (Private Automatic Branch Exchange). When a SIP incoming call arrives at the system, all the handset and the Tablet will be ringing and the first off-hook one will take the call.

It can be appreciated that the Tablet can also be provided with its own SIP stack, in which case the Tablet can be considered as an advanced DECT handset and receive voice data from the DECT base. That is, both the DECT base and the Tablet can have respective SIP account and the SIP server needs to support sip-forking and allow the registration from several devices with the same account. In the present invention, no further detailed description will be provided for this case.

For the practical implementation of the video phone system according to the embodiment of the invention, the DECT base and the Tablet may need to have the following functions:

Tablet:

Terminal for private communication protocol;

Media transactor;

NAT (Network Address Translation) traverse.

In addition, the Tablet may also realize a lightweight video framework for camera, display out, encoder, decoder and video mixer (preferably Gstreamer) for purpose of the video call. It can build pipeline according to video information from the DECT base.

DECT Base:

Terminal for private communication protocol;

To integrate the terminal with SIP stack;

Support video in SIP application;

In this embodiment, since the Tablet is not provided with a SIP stack, the DECT base also needs to support video for SIP signaling and maintain a state machine for remote video on the Tablet.

A video control is needed for the video data exchange on both the Tablet and the DECT base:

There is a specification of communication between the DECT base and the Tablet for purpose of video control of the video data transmitted from the DECT base and the Tablet. The communication is network-independent, which can be realized on DECT transport channel or on WiFi.

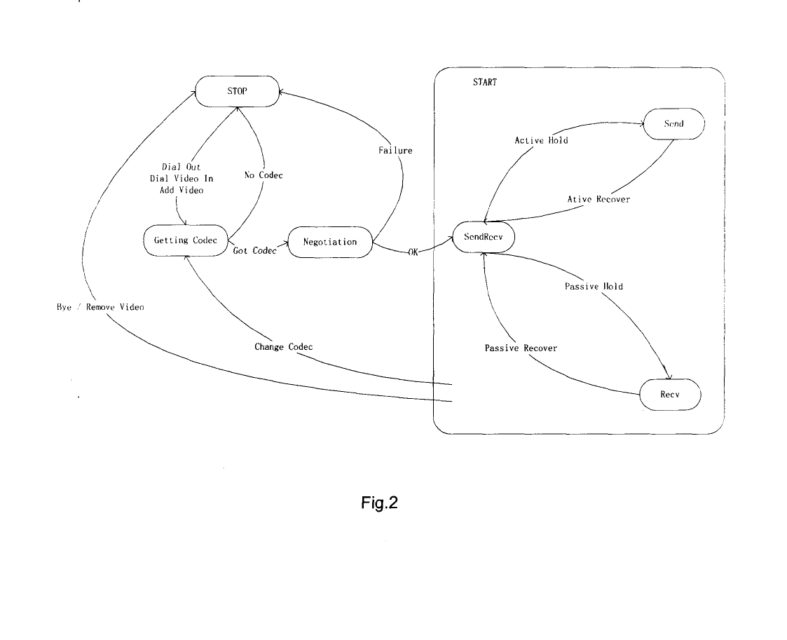

FIG. 2 is an exemplary diagram showing the state machine of video on the DECT base according to an embodiment of the present invention.

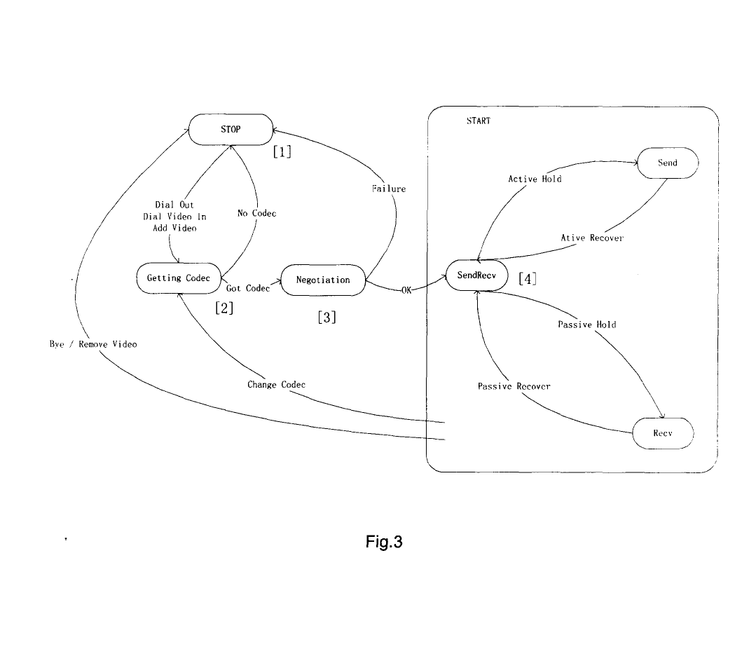

The DECT base handles state machine to control remote video on the Tablet during call initiation, negotiation and the whole video call. The initial state is “STOP”. When a SIP video call is initiated (sip-INVITE), the DECT base will send SDP (Session Description Protocol) describing video information like IP, port and codecs. For building the SDP, the DECT base needs to get video information from the Tablet through private protocol. This process can be carried out in a conventional flow, which is shown in FIG. 3), after which video enters the corresponding state and at last becomes “START” if success. After call ends (sip-BYE), the DECT base turns video off on the Tablet and the state becomes “STOP”.

There are sub-states within “START”. For example, if a user on the Tablet wants to hold actively the call, the DECT base will turn the state to “send” from “sendrecv” and send sip-reINVITE to the remote peer. After the user recovers the call, the state becomes “sendrecv” from “send”.

During a call, the control works also in case of call hold, call transfer or other actions happen. For example, when a user wants to close video temporarily, the DECT base turns remote video from “sendrecv” to “stop”.

FIG. 3 is an exemplary diagram showing a state transfer of an incoming call according to an embodiment of the present invention.

During ringing, SM is getting codec from the Tablet. After SIP negotiation, the DECT base will control the Tablet to start video sending and receiving. As shown in FIG. 3, the START state also has three sub-states for normal call and hold/recover.

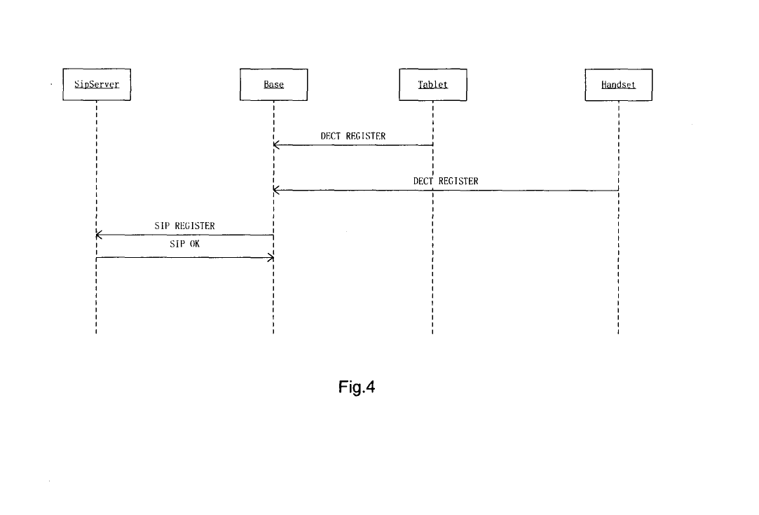

FIGS. 4-14 are exemplary diagrams showing sequence charts of respective operations of the video phone system according to an embodiment of the invention.

The following references are used throughout FIGS. 4-14:

“EXT”: extended private signaling for video control between the DECT base and the Tablet

“DECT”: DECT signaling

“SIP ”: SIP signaling

“Active”: the Tablet initiates dialog

“Passive”: the Tablet received dialog initiated by remote peer

FIG. 4 shows the registration procedure.

In home network, all of Tablets and DECT handsets are registered on the DECT base though DECT, and the DECT base is registered on a SIP server through SIP.

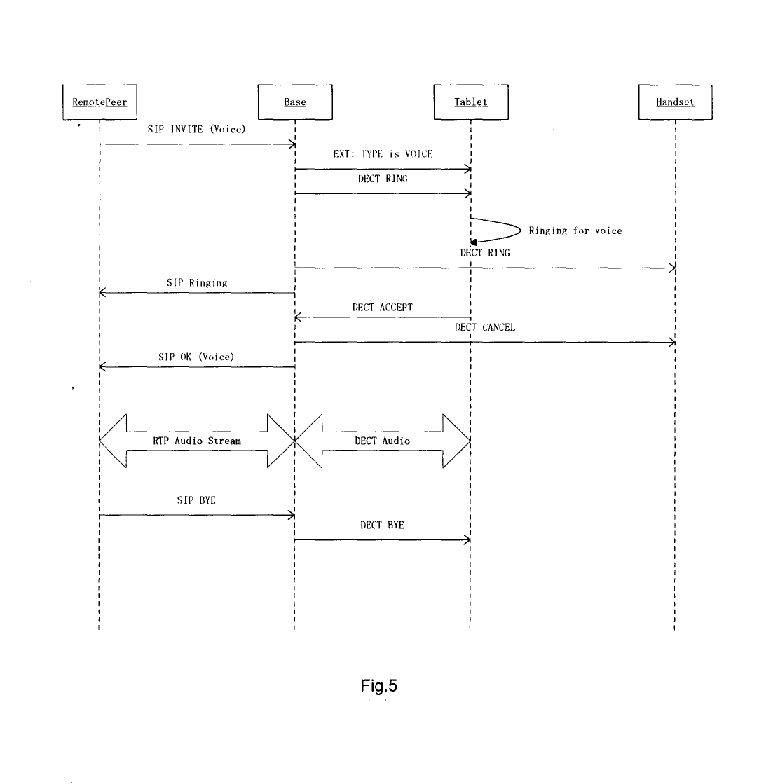

FIG. 5 shows the procedure for an incoming voice call.

As shown in FIG. 5, when the DECT base receives an INVITE, it will tell the Tablet the type of incoming call, after which the Tablet will play the corresponding ringtone.

FIG. 5 shows an incoming voice call to the DECT base which then makes all of the Tablets and DECT handsets be ringing through DECT. The first off-hook one will take the call and ringing of the rest devices will be canceled. The voice stream will transport via the DECT base, which is bridge between SIP and DECT.

The DECT base tells also Tablet the call-type is voice. The Tablet knows the call is voice, than will select ringtone specific for voice. This feature is for notifying a user with different ringtone.

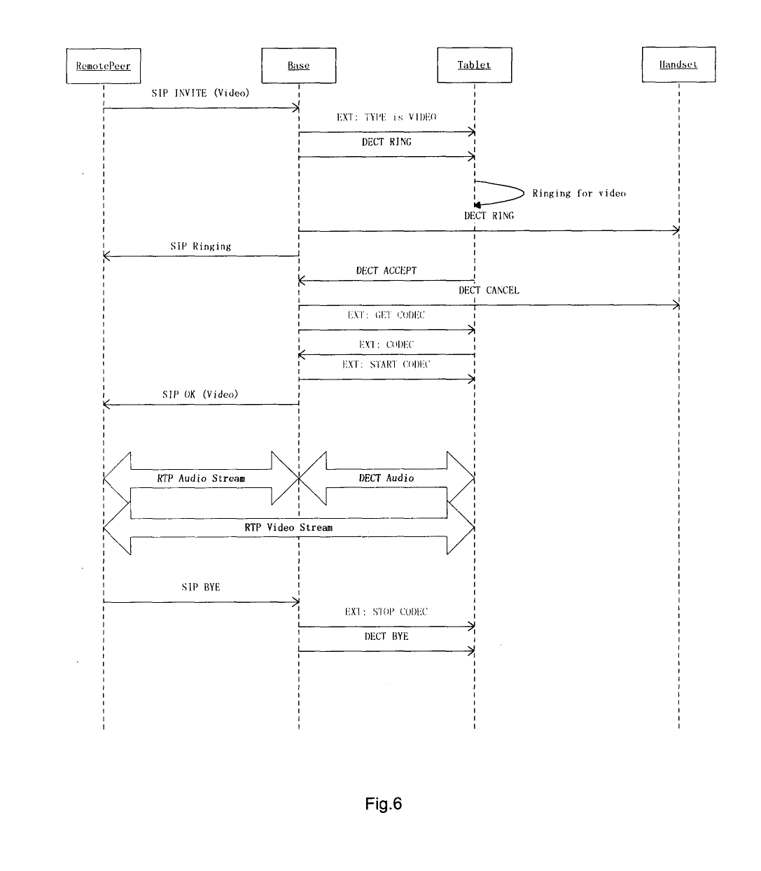

FIG. 6 shows the procedure for an incoming video call.

After ringing, the DECT base will get a list of video codec from the Tablet and negotiate with the remote peer. If the negotiation is successful, the DECT base will turn the video state to “START” and send specific command to the Tablet. The terminal on Tablet listening to the command will start video to display and start camera to capture video on the Tablet. In this command, the DECT base will tell the Tablet the detailed parameters of the video.

During a video call, a voice stream is transmitted via the DECT base, but a video stream is transmitted between the remote peer and the Tablet, which is on WiFi, not via the DECT base.

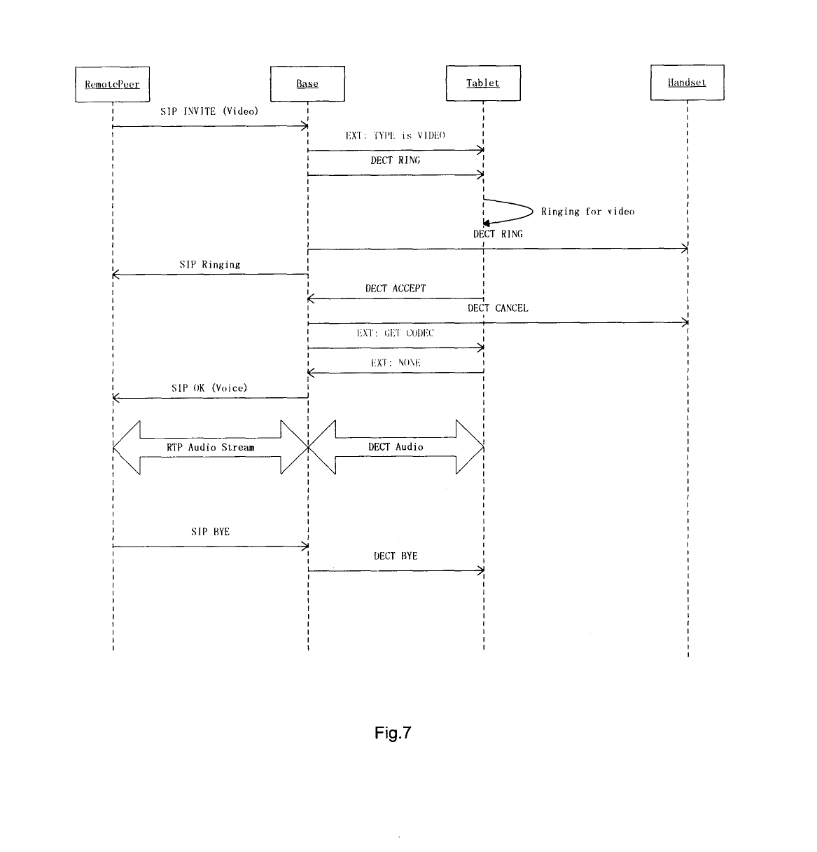

FIG. 7 shows the procedure for an incoming video call which is accepted as a voice call.

The Tablet can accept an incoming call as voice call by return “no video codec” to the base.

Although incoming call is video call, a user of the Tablet has chance to take it as voice call. For this scenario, when the DECT base gets codec from the Tablet, the Tablet will return “no codec”. Then the DECT base will negotiate with the remote peer with voice call.

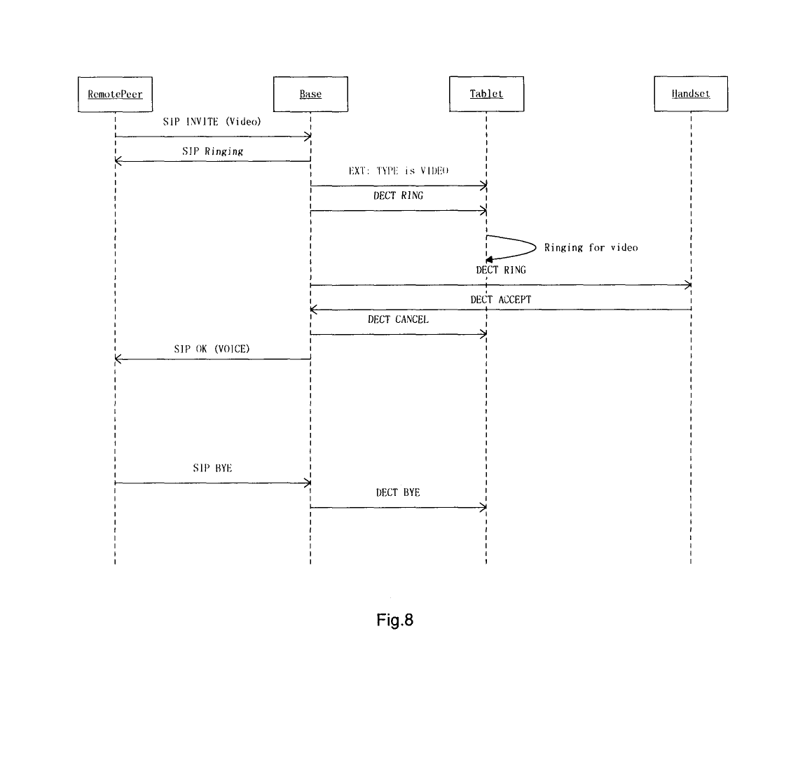

FIG. 8 shows the procedure for an incoming video call which is off-hook on a DECT handset.

As shown in FIG. 8, if first off-hook is on a DECT handset, the DECT base will cancel the DECT call to the Tablet.

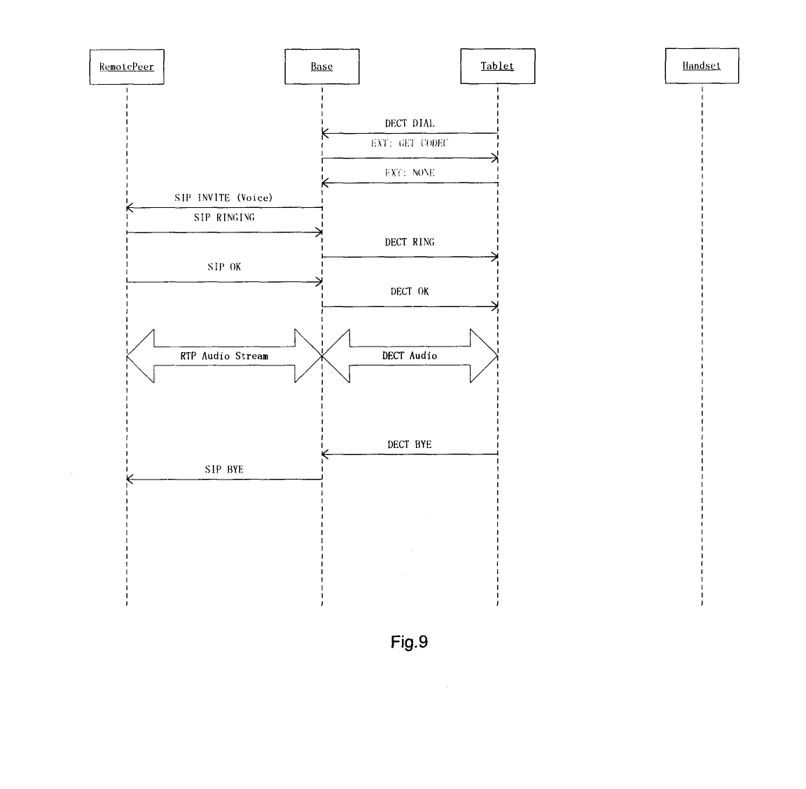

FIG. 9 shows the procedure for an outgoing voice call.

As shown in FIG. 9, When the Tablet detects the DECT base is dialing out, the DECT base will get list of video codec, the Tablet can provide “no codec” to dial out voice call.

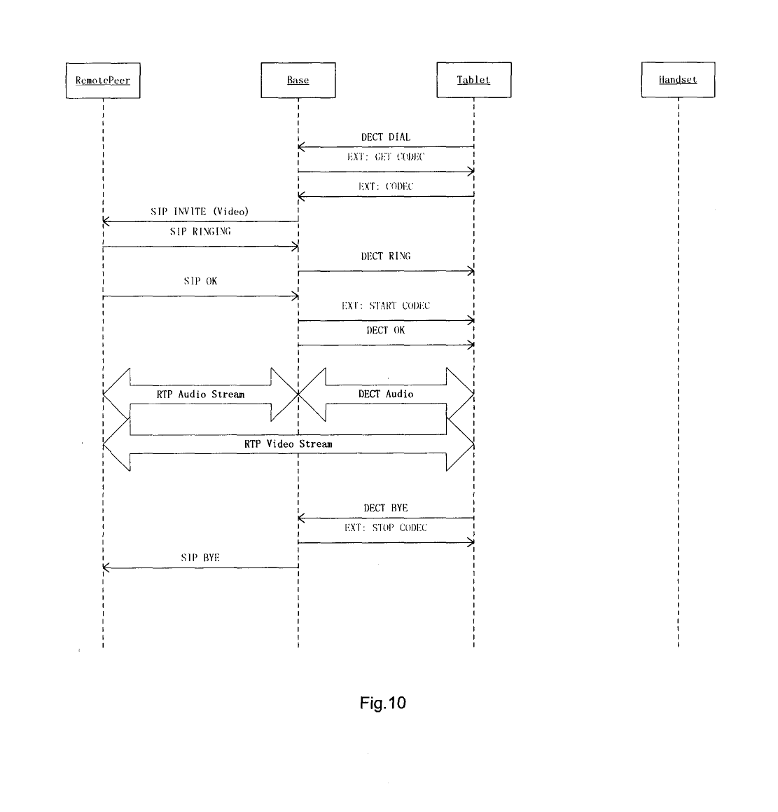

FIG. 10 shows the procedure for an outgoing video call.

The above FIGS. 9 and 10 describe how the DECT base deals with dial-out from the Tablet. Tablet dials-out though DECT, and the DECT base will get video information from the Tablet and selects dial out SIP call of voice or video. The process is similar to the dial-in process described above with reference to FIGS. 5 and 6.

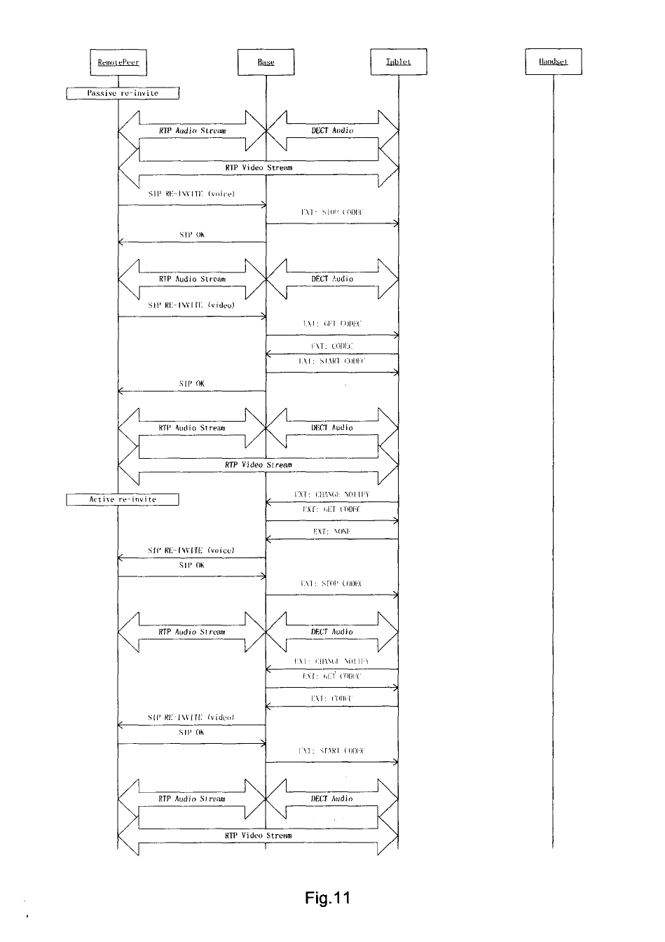

FIG. 11 shows the procedure for a Re-invite of the Tablet.

If the Tablet wants to change codec, it will sends “notify” to the DECT base which will get the codec and then send out re-invite on SIP.

Four scenarios are shown in the FIG. 11 as follows:

ReINVITE from remote peer (passive in the view of Tablet) requires video to voice

ReINVITE from remote peer requires voice to video

ReINVITE from local Tablet (active in the view of Tablet) requires video to voice

ReINVITE from local Tablet (active in the view of Tablet) requires voice to video

As shown in FIG. 11, the DECT base maintains the state of video and controls the Tablet. If reINVITE is active, the Tablet will notify the DECT base to change video.

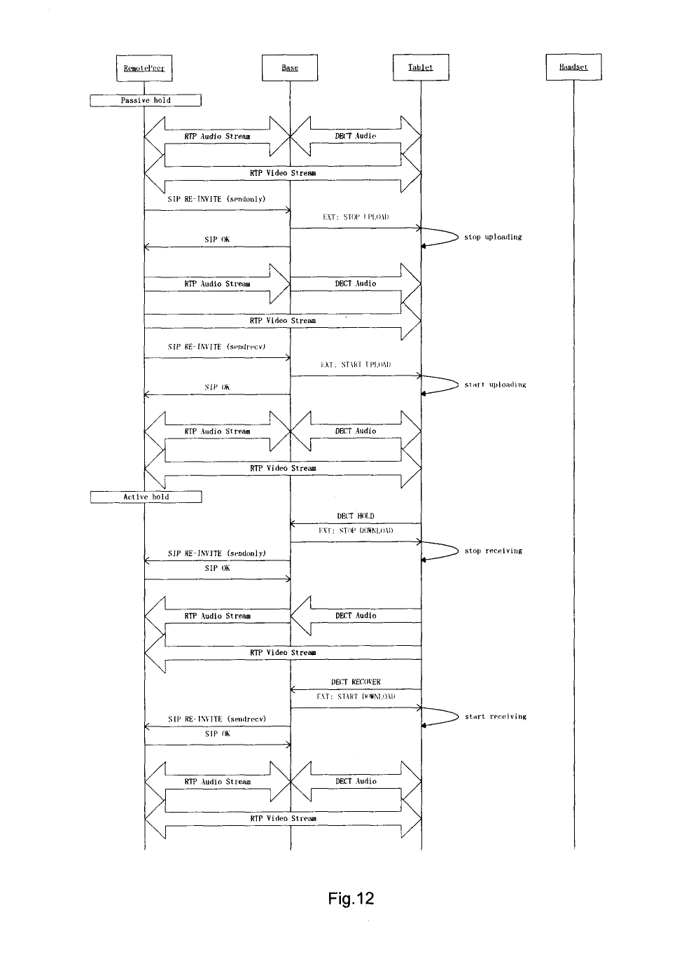

FIG. 12 shows the procedure for a Hold/Recover of the Tablet.

In this case, the Tablet needs to control the direction of video according to commands from the DECT base.

Call hold and recover are traditional scenarios on telephone. SIP supports these scenarios by sending reINVITE with SDP, which describes a stream direction. The commands and state machine between the DECT base and Tablet support these features. For example, hold on Tablet means “send only” in reINVITE, state of video becomes “send”, and the DECT base stops video download on Tablet.

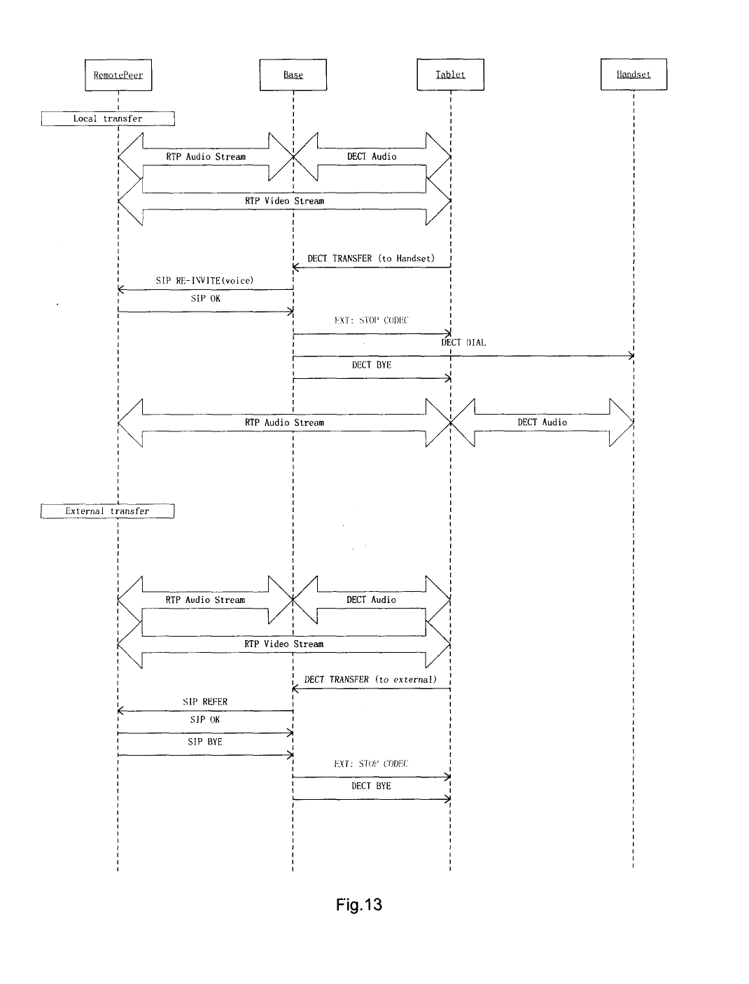

FIG. 13 shows the procedure for a video call transfer.

There are two kinds of call transfer. The first one is DECT transfer between the Tablet and handset at home. The SIP call established between the DECT base and the remote peer is not changed. When call is transferred from Tablet with video to DECT handset without video, the DECT base will stop video and then initiate a DECT transfer. The second is SIP transfer between Tablet and remote peer. The DECT base initiates a SIP transfer, and the DECT base will stop video on Tablet if the transfer target has no video.

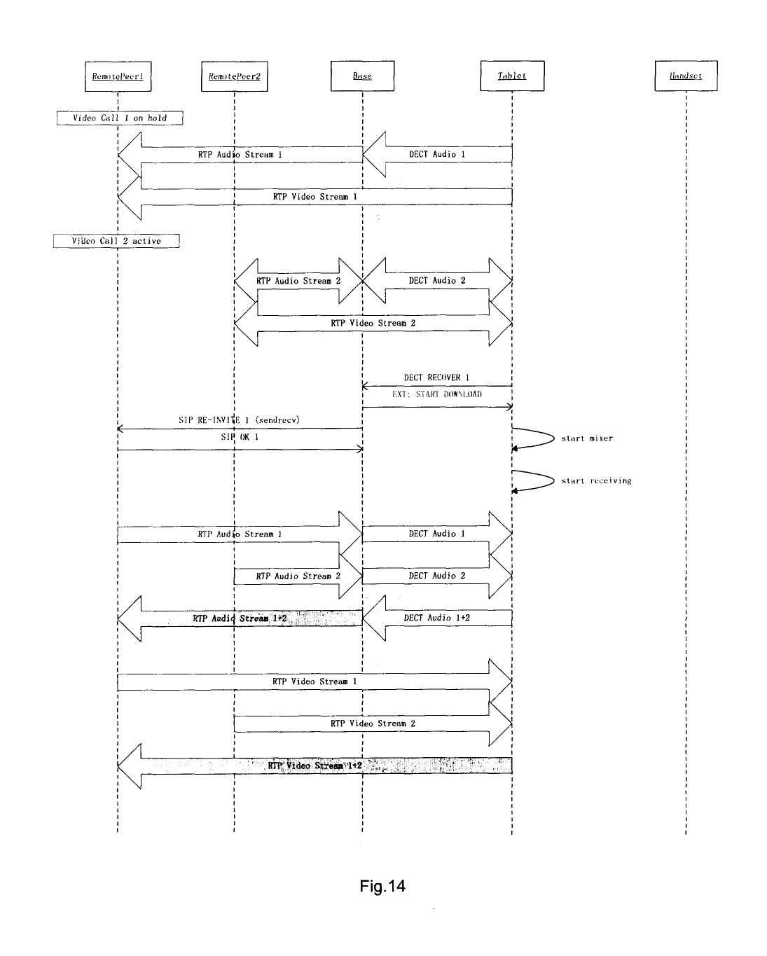

FIG. 14 shows the procedure for a video conference call.

The Tablet needs to have a video mixer for purpose of a video conference call.

FIG. 14 shows an ad-hoc SIP call conferencing. The procedure shown in FIG. 14 can be briefly described as a hold, recover and mixing process. Specifically, firstly it is to hold a first call, and then initiate a second call. Finally the first call will be recovered and the first and second calls will be mixed.

It is important for VoIP to traverse NAT (Network Address Translation). There are several techniques that have been developed to facilitate the traversal of NAT. These techniques were described in the document “Considerations for Selection of Techniques for NAT Traversal”, draft-iab-nat-traversal-considerations-00, J. Rosenberg. These techniques can be summarized as follows:

Modify the NAT: Application Layer Gateways (ALG)

Modify the Clients: Unilaternal Self-Address Fixing (UNSAF)
STUN(Simple Traversal of User Datagram)
TURN (Traversal Using Relays around NAT)
ICE (Interactive Connectivity Establishment)

Modify the Servers: Server Involvement in NAT Navigation (SINN) SBC (Session Border Controller)

Modify the NAT and the Client: RSIP (Realm Specific Internet P o ocol), NSIS (Next Steps in Signaling)

Modify the NAT and the Server: MIDCOM (Middlebox Communications)

Modify the Clients and Servers: Protocol Update

Modify Everything: IPv6

STUN and SBC can be used for VoIP to traverse NAT in the video phone system of the embodiment of the present invention.

For SBC, the voice RTP (Real-time Transport Protocol) transportation is between SBC and the DECT base, but video RTP is between SBC and the Tablet. In the operations of the Tablet for NAT traverse, normally RTP to SBC (even “recvonly” for Tablet) will be initiated first, after which NAT binding will be created. And binding on NAT needs to be kept alive.

For STUN, there will be a STUN client on the Tablet and the binding on NAT needs to be kept alive.

According to the embodiment of the present invention, audio and video data are transmitted at separated channels. As SIP-DECT bridge, the DECT base does not have big delay, so AV synchronization is not necessary.

With the video phone system according to an embodiment of the invention, since the voice data is transmitted on DECT channel and the video data is transmitted on WiFi channel, good quality of both the voice and the video data is expected. Voice call on DECT has longer talk time and better coverage indoor and outdoor than that on WiFi. In addition, the system has a seamless hand-over between DECT base, which is better than a hand-over on WiFi.

For requirement “simultaneous” ringing on several home devices, the solution also does not SIP-forking on the proxy server of operator.

It will be understood that the present invention has been described purely by way of example, and modifications of detail can be made without departing from the scope of the invention. Each feature disclosed in the description and (where appropriate) the claims and drawings may be provided independently or in any appropriate combination. Features may, where appropriate be implemented in hardware, software, or a combination of the two.

1-9. (canceled)

10. An apparatus, comprising:
a gateway for communicating voice data of a video call stream over a voice channel between at least one terminal and a peer; and
an access point for communicating video data of the video call stream over a data channel between at least one video terminal and the peer.

11. The apparatus according to the claim 10, wherein the apparatus is communicating the video call stream with the peer over a SIP network.

12. The apparatus according to the claim 11, wherein the gateway is a VoIP gateway for communicating the voice data over a DECT channel between at least one DECT terminal and the peer; and
the access point is a WiFi access point for communicating the video data over a WiFi channel between at least one WiFi video terminal and the peer.

13. The apparatus according to the claim 12, wherein the apparatus is a DECT base.

14. The apparatus according to the claim 13, wherein the at least one DECT terminal is a DECT handset registered to the DECT base.

15. The apparatus according to the claim 13, wherein the at least one WiFi video terminal is a mobile device which supports DECT and is registered to the DECT base.

16. The apparatus according to the claim 13, wherein the at least one WiFi video terminal is a multimedia mobile device which supports WiFi and is registered to the DECT base.

17. The apparatus according to the claim 13, wherein the DECT base is registered to a SIP server of the SIP network.

18. The apparatus according to the claim 12, wherein Simple Traversal of User Datagram (STUN) and Session Border Controller (SBC) is used for the VoIP gateway to traverse Network Address Translation (NAT).

19. The apparatus according to the claim 18, wherein the voice Real-time Transport Protocol (RTP) transportation is between Session Border Controller (SBC) and the apparatus and the video Real-time Transport Protocol (RTP) is between Session Border Controller SBC and the WiFi video terminal.
